(19) United States
(12) Patent Application Publication
(10) Pub. No.: US 2023/0011370 A1
(43) Pub. Date: Jan. 12, 2023

(54) COMPONENT MADE OF THERMOPLASTIC COMPOSITE MATERIAL COMPRISING AT LEAST ONE TIE LAYER BASED ON AT LEAST ONE AMORPHOUS THERMOPLASTIC RESIN

(71) Applicant: Airbus Operations SAS, Toulouse (FR)

(72) Inventor: Emilie PETIOT, TOULOUSE (FR)

(21) Appl. No.: 17/858,430

(22) Filed: Jul. 6, 2022

(30) Foreign Application Priority Data
Jul. 8, 2021 (FR) 2107414

(51) Int. Cl. C09D 171/12; C09D 181/04; C09D 171/02

(52) U.S. Cl. CPC C09D 171/12; C09D 181/04; C09D 171/02

(57) ABSTRACT

A component including a body having a first surface and a matrix made of semicrystalline thermoplastic resin, a coating at least partially covering the first surface and a lightning protection layer having a matrix, positioned against the surface, between the body and the coating. The matrix of the lightning protection layer is based on at least one amorphous thermoplastic resin.

### CROSS REFERENCE TO RELATED APPLICATIONS

This application claims the benefit of the French patent application No. 2107414 filed on Jul. 8, 2021, the entire disclosures of which are incorporated herein by way of reference.

### FIELD OF THE INVENTION

The present application relates to a component made of thermoplastic composite material comprising at least one tie layer based on at least one amorphous thermoplastic resin.

According to an embodiment illustrated in FIG. 1, a wall of an aircraft fuselage comprises a body 10 having a first surface 10.1 oriented toward the outside of the fuselage and a second surface 10.2 oriented toward the inside of the fuselage. This body 10 is made of thermosetting composite material and comprises fibers embedded in a thermosetting resin matrix.

According to one configuration, the wall comprises a lightning protection layer 12 known as an LSP (lightning strike protection) layer added to the first surface 10.1. This lightning protection layer 12 has a metallic grille embedded in a matrix made of thermosetting resin.

The wall of the fuselage also has a paint layer 14 added to the lightning protection layer 12. In order to promote the attachment of this paint layer 14, the wall of the fuselage comprises at least one primer layer 16 interposed between the lightning protection layer 12 and the paint layer 14. According to an embodiment visible in FIG. 1, the wall of the fuselage comprises two primer layers 16, 16′ between the lightning protection layer 12 and the paint layer 14.

Certain zones of the second surface 10.2 are covered with a protective paint layer 18. In order to promote the attachment of this protective paint layer 18, the wall of the fuselage comprises at least one primer layer 20 interposed between the second surface 10.2 of the body 10 and the protective paint layer 18.

According to an embodiment illustrated in FIG. 2, the body 10 of the wall of the fuselage is made of thermoplastic composite material. In addition, the lightning protection layer 12 comprises a matrix made of thermoplastic resin.

In this case, it is necessary to perform a surface preparation step before the step of applying the primer layer 16 in order to increase the wettability 22 of the lightning protection layer 12 so as to promote the attachment of the primer layer 16. In addition, it is necessary to use a solvent-based primer layer 16.

This embodiment for the components made of thermoplastic composite material is not satisfactory since the surface preparation step is relatively long and significantly increases the cost of the components. In addition, it is not suitable for components with large dimensions. Finally, the use of a solvent-based primer layer has a negative impact on the environment.

The present invention seeks to remedy all or some of the drawbacks of the prior art.

### SUMMARY OF THE INVENTION

To this end, the invention relates to a component comprising a body having a first surface and a matrix made of semicrystalline thermoplastic resin, a coating at least partially covering the first surface and a lightning protection layer having a matrix, positioned against the first surface, between the body and the coating, wherein the matrix of the lightning protection layer is based on at least one amorphous thermoplastic resin.

By virtue of the material of the matrix of the lightning protection layer, it is no longer necessary to prepare the surface to which the primer layer or the coating is applied so as to increase its wettability and thus the attachment of said layers. Simple cleaning is sufficient. This material also makes it possible to be able to use a water-based primer layer and/or coating.

According to another feature, the lightning protection layer comprises a first face oriented toward the body, a second face opposite the first face and a thickness corresponding to a dimension taken between the first and second faces.

According to a first variant, a part of the thickness of the lightning protection layer, extending from the second face, is made of amorphous thermoplastic resin or a mixture of at least one amorphous thermoplastic resin and at least one semicrystalline thermoplastic resin.

According to a second variant, the lightning protection layer is made over its entire thickness of an amorphous thermoplastic resin or a mixture of at least one amorphous thermoplastic resin and at least one semicrystalline thermoplastic resin.

According to another feature, the body comprises, at the first surface, a matrix made of amorphous thermoplastic resin or a mixture of at least one amorphous thermoplastic resin and at least one semicrystalline thermoplastic resin.

According to another feature, the component comprises a film, separate from the lightning protection layer, made of amorphous thermoplastic resin or a mixture of at least one amorphous thermoplastic resin and at least one semicrystalline thermoplastic resin.

According to another feature, the mixture of at least one amorphous thermoplastic resin and at least one semicrystalline thermoplastic resin comprises at least 50% by weight of amorphous thermoplastic resin.

According to another feature, the component comprises at least one water-based primer layer interposed between the lightning protection layer and the coating.

The invention also relates to an aircraft comprising a component according to one of the preceding features.

### BRIEF DESCRIPTION OF THE DRAWINGS

Other features and advantages will become apparent from the following description of the invention, which description is given solely by way of example, with reference to the appended drawings in which:

FIG. 1 is a section through a part of a component made of thermosetting composite material, illustrating an embodiment of the prior art,

FIG. 2 is a section through a part of a component made of thermoplastic composite material, illustrating an embodiment of the prior art,

FIG. 3 is a section through a part of a component made of thermoplastic composite material, illustrating an embodiment of the invention, and

FIG. 4 is a section through a part of a component made of thermoplastic composite material, illustrating an embodiment of the invention.

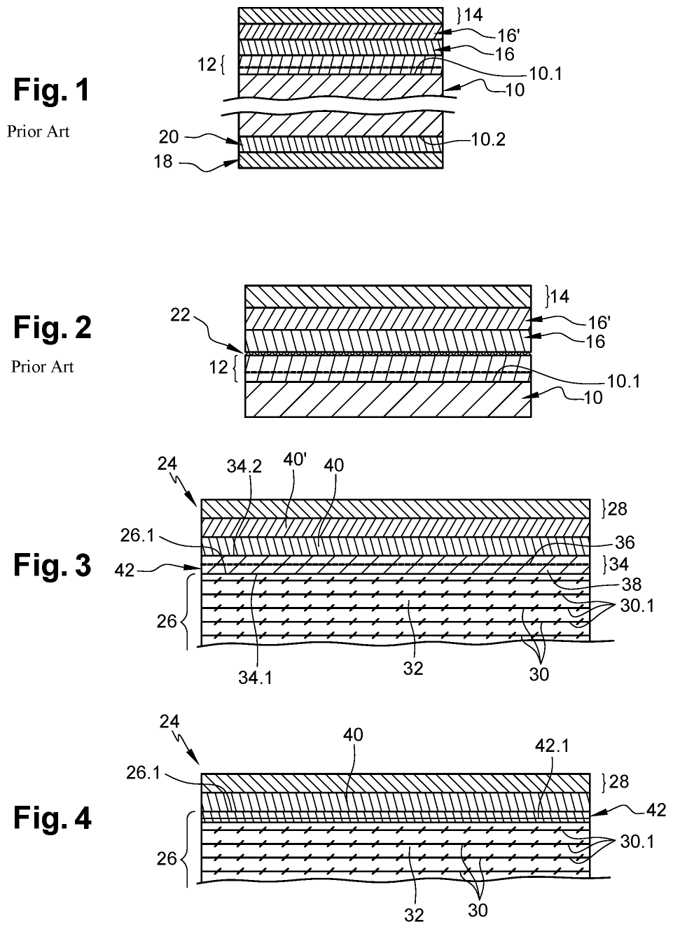

### DETAILED DESCRIPTION OF PREFERRED EMBODIMENTS

According to an embodiment illustrated in FIG. 4, a component 24 comprises a body 26 having a first surface 26.1 and a coating 28, such as a paint layer or a protective paint layer, for example, at least partially covering the first surface 26.1. Preferably, this coating 28 is a water-based paint layer.

According to one application, the component 24 is a wall of an aircraft. Of course, the invention is not limited to this application.

The body 26 is made of thermoplastic composite material and has fibers 30 embedded in a thermoplastic resin matrix 32.

According to one configuration, the fibers 30 are in the form of plies of fibers 30.1 that are superposed. By way of example, the fibers 30 are made of carbon.

According to one embodiment, the thermoplastic resin is a semicrystalline thermoplastic resin. By way of example, the resin is chosen from polyetheretherketones (PEEK), polyaryletherketones (PAEK), polyetherketoneketones (PEKK) and polyphenylene sulfides (PPS).

The components 24 having a body 26 made of thermoplastic composite material have, in particular, the advantage of making it possible to realize connections between the components by welding, unlike those made of thermosetting composite material.

According to one embodiment, the component 24 comprises a lightning protection layer 34, known as an LSP (lightning strike protection) layer, positioned on the first surface 26.1 of the body 26. According to one embodiment, this lightning protection layer 34 comprises at least one grille, mesh, expanded metal or perforated sheet 36 that is metallic, made of copper or bronze for example, embedded in a matrix 38.

The lightning protection layer 34 comprises a first face 34.1 oriented toward the body 26 and a second face 34.2, opposite the first face 34.1, oriented toward the coating 28.

According to one configuration, the component 24 comprises at least one primer layer 40, applied to the second face 34.2 of the lightning protection layer 34, interposed between the latter and the coating 28. According to a configuration visible in FIG. 3, the component 24 comprises two primer layers 40, 40′.

According to one embodiment, at least one primer layer 40, 40′ or each primer layer 40, 40′ is a solvent-based primer layer.

According to another embodiment, at least one primer layer 40, 40′ or each primer layer 40, 40′ is a water-based primer layer. This type of primer layer makes it possible to reduce the environmental impact.

According to a first embodiment, the matrix 38 of the lightning protection layer 34 is made of an amorphous thermoplastic resin or a mixture of at least one amorphous thermoplastic resin and at least one semicrystalline thermoplastic resin. According to one configuration, the amorphous thermoplastic resin is chosen from polyetherimides (PEI), polyethersulfides (PES) or the like.

The use of an amorphous thermoplastic resin makes it possible to obtain satisfactory attachment between the lightning protection layer 34 and the primer layer 40 without it being necessary to perform a step of preparing the second surface 34.2. In addition, this type of resin makes it possible to be able to use a water-based primer layer 40.

The lightning protection layer 34 has a thickness corresponding to a dimension taken between the first and second faces 34.1, 34.2. According to one variant, the lightning protection layer 34 is made, over its entire thickness, of an amorphous thermoplastic resin or a mixture of at least one amorphous thermoplastic resin and at least one semicrystalline thermoplastic resin. According to another variant, only a part of the thickness of the lightning protection layer 34, extending from the second face 34.2, is made of amorphous thermoplastic resin or a mixture of at least one amorphous thermoplastic resin and at least one semicrystalline thermoplastic resin. According to one embodiment, before its consolidation, the lightning protection layer 34 has an amorphous thermoplastic resin film on its second face 34.2.

According to a second embodiment, the matrix 38 of the lightning protection layer 34 is a thermoplastic resin compatible with the resin of the matrix 32 of the body 26. According to one configuration, the matrices 32, 38 of the body 26 and of the lightning protection layer 34 are made from the same resin, such as a semicrystalline thermoplastic resin.

According to this second embodiment, the component 24 comprises an amorphous thermoplastic resin film interposed between the lightning protection layer 34 and the primer layer 40.

According to another embodiment, visible in FIG. 4, the primer layer 40 or the coating 28 is in contact with the surface 26.1 of the body 26. According to this embodiment, the component 24 comprises an amorphous thermoplastic resin layer or film 42 interposed between the surface 26.1 of the body 26 and the primer layer 40. This amorphous thermoplastic resin layer 42 can comprise a reinforcing ply 42.1.

In a variant, a part of the thickness of the body 26, extending from the surface 26.1, is made of amorphous thermoplastic resin or a mixture of at least one amorphous thermoplastic resin (PEI) and at least one semicrystalline thermoplastic resin (PEEK, PAEK, etc.). According to one embodiment, before its consolidation, the body 26 comprises a ply of fibers 30.1 that is positioned on the surface 26.1, this ply of fibers 30.1 being pre-impregnated with an amorphous thermoplastic resin or a mixture of at least one amorphous thermoplastic resin (PEI) and at least one semicrystalline thermoplastic resin (PEEK, PAEK, etc.). In a variant, the body 26 comprises, before its consolidation, an amorphous thermoplastic resin film positioned on the surface 26.1.

Of course, the invention is not limited to these embodiments. Thus, it is possible for the component 24 not to comprise any primer layer 40, the coating 28 being applied directly to the body 26 or the lightning protection layer 34.

Whatever the embodiment, the component 24 comprises at least one support layer made of a material having a thermoplastic resin matrix chosen from a body 26 of the component 24 and a lightning protection layer 34, at least one application layer at least partially covering the support layer, such as a coating 28 or a primer layer 40, and at least one tie layer 42 having a matrix based on at least one amorphous thermoplastic resin positioned at an interface connecting the support layer and the application layer.

According to a first variant, the tie layer 42 is distinct from the support layer, namely from the body 26 or from the lightning protection layer 34. According to another variant, the tie layer 42 is incorporated in the support layer, namely in the body 26 or in the lightning protection layer 34.

In some cases, the matrix of the tie layer 42 comprises a single amorphous thermoplastic resin. In other cases, the matrix of the tie layer 42 comprises a mixture of at least one amorphous thermoplastic resin and at least one semicrystalline thermoplastic resin, the amorphous thermoplastic resin representing at least 50% by weight of the mixture of resins.

According to one embodiment, the tie layer 42 comprises at least one reinforcing ply 42.1, in particular made of carbon, glass or other fibers.

This tie layer 42 has excellent adhesion properties. As a consequence, by virtue of this tie layer 42, it is no longer necessary to prepare the surface to which the primer layer 40 or the coating 28 is applied so as to increase its wettability and thus the attachment of said layers. Simple cleaning is sufficient. This tie layer 42 also makes it possible to be able to use a water-based primer layer 40 and/or coating 28.

According to other advantages, the manufacturing methods of the prior art can be used to produce the body 26 and the lightning protection layer 34 of the component 24. Likewise, the application methods of the prior art can be used to deposit the various coatings 28 and primer layers 40, 40′.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A component comprising:
a body having a first surface and a matrix made of semicrystalline thermoplastic resin,
a coating at least partially covering the first surface, and
a lightning protection layer having a matrix, positioned against the first surface, between the body and the coating,
wherein the matrix of the lightning protection layer is based on at least one amorphous thermoplastic resin.

2. The component as claimed in claim 1,
wherein the lightning protection layer comprises a first face oriented toward the body, a second face opposite the first face and a thickness corresponding to a dimension taken between the first and second faces, and
wherein a part of the thickness of the lightning protection layer, extending from the second face, is made of amorphous thermoplastic resin or a mixture of at least one amorphous thermoplastic resin and at least one semicrystalline thermoplastic resin.

3. The component as claimed in claim 1,
wherein the lightning protection layer comprises a first face oriented toward the body, a second face opposite the first face and a thickness corresponding to a dimension taken between the first and second faces, and
wherein the lightning protection layer is made over its entire thickness of an amorphous thermoplastic resin or a mixture of at least one amorphous thermoplastic resin and at least one semicrystalline thermoplastic resin.

4. The component as claimed in claim 1, wherein the body comprises, at the first surface, a matrix made of amorphous thermoplastic resin or a mixture of at least one amorphous thermoplastic resin and at least one semicrystalline thermoplastic resin.

5. The component as claimed in claim 1, wherein the component comprises a film, separate from the lightning protection layer, made of amorphous thermoplastic resin or a mixture of at least one amorphous thermoplastic resin and at least one semicrystalline thermoplastic resin.

6. The component as claimed in claim 2, wherein the mixture of at least one amorphous thermoplastic resin and at least one semicrystalline thermoplastic resin comprises at least 50% by weight of amorphous thermoplastic resin.

7. The component as claimed in claim 1, further comprising at least one water-based primer layer interposed between the lightning protection layer and the coating.

8. An aircraft comprising a component as claimed in claim 1.
